(19) United States
(12) Patent Application Publication
(10) Pub. No.: US 2005/0107135 A1
(43) Pub. Date: May 19, 2005

(54) Terminal, system, method and computer program product for displaying an indication of bandwidth

(75) Inventors: Douglas Deeds, Bedford, TX (US); Andrew S. Wilken, Bedford, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/715,790

(22) Filed: Nov. 18, 2003

(51) Int. Cl. H04M 1/00

(52) U.S. Cl. 455/575.1

(57) ABSTRACT

A terminal adapted to communicate via a communications system with a detectable available bandwidth includes a transmitter and a receiver for transmitting and receiving a plurality of different communications signals, respectively. Also, the terminal includes a display and a controller that drives the display. The controller is capable of detecting both available and required bandwidth levels, both the bandwidth for signal transmission and signal reception, and the type of communication signals being transmitted and received by the terminal, and controlling the operation of the display in response to thereto. As such, the display can inform the user of the terminal of the available and required bandwidth levels for transmitting and receiving a given type of communication signal.

### FIELD OF THE INVENTION

The present invention relates generally to mobile terminals such as mobile telephones and, more particularly, relates to a mobile terminal, system, method, and computer program product for detecting and displaying an indication of the bandwidth available via a communications system and, in some embodiments, a mobile terminal, system, method and computer program product for detecting and displaying an indication of the bandwidth required by the mobile terminal to transmit and receive communications signals.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. Modern mobile terminals have the ability to receive these services via a number of different communications networks and each type of network has a varying amount of available bandwidth depending not only on the type of network but also the current location of the mobile terminal in relation to other network components as well as the number of users also accessing the network at a given time. In addition, the bandwidth required by mobile terminals is constantly changing depending on the type and format of the data that the mobile terminal user is sending and receiving at a given time.

3G Mobile terminals communicate using various communications networks, such as Wireless Local Area Networks (WLAN), radio-frequency links (such as General Packet Radio Service (GPRS)), local infrared links (such as IrDA), and other proprietary links (such as Bluetooth). In addition some mobile terminals have the capability to use these various networks concurrently to widen the total available bandwidth spectrum. Concurrent use of multiple communication systems on a given mobile terminal, however, can quickly use up available bandwidth such that one or more of the concurrent forms of communication may be compromised.

Conventional terminals, such as mobile telephones, generally include a display capable of conveying network signal strength. However, there exists a need to communicate to the mobile terminal user, an indication of both available network bandwidth, and the current bandwidth required by the terminal to transmit and receive information at a given time. This need becomes crucial as mobile terminal users seek to use concurrent modes of communication on a terminal configured to communicate via more than one type of network. Furthermore, there exists a need to quickly convey this information to the mobile terminal user in a simple visual format so that the user is aware of network constraints on the communications systems being utilized by the mobile terminal.

### SUMMARY OF THE INVENTION

In light of the foregoing background, the present invention provides an improved mobile terminal system, method and computer program product for visually representing the bandwidth available on a communications network and, in some embodiments, the bandwidth required by the mobile terminal as a result of its current use of one or more communications networks. The terminal, method and computer program product of the present invention advantageously associate the available network bandwidth with a first icon and/or color. In this regard, the terminal may include a display and a controller that visually represents the available bandwidth upon the display by means of the first icon and/or color. In addition, the controller may also be configured to detect the bandwidth required of the communications networks being accessed by the mobile terminal and visually represent the required bandwidth on the display in relation to the available bandwidth, such as by using a second icon to represent the required bandwidth. As such, a user of the terminal is continually kept informed of the available bandwidth of the communication network being accessed by the mobile terminal as well as the required bandwidth to communicate via the selected networks. The terminal, method and computer program product of the present invention therefore provide solutions to the needs presented by the newest mobile terminal technology and provide additional advantages.

According to one aspect of the present invention, a terminal adapted to communicate via a plurality of different mobile communications system is provided. The terminal includes a transmitter and a receiver for transmitting and receiving communications signals, respectively. The terminal also includes a display capable of visually representing the available bandwidth of a current communications system. Additionally, the display can be adapted to visually represent the bandwidth that is required to transmit and receive signals on the current communications system. To control the operation of the display, the terminal includes a controller. In this regard, the controller determines the available bandwidth of the current communications system and alters the appearance of the display based on the determination of available bandwidth. Additionally, the controller can be adapted to determine the required bandwidth for transmitting and receiving signals on the current communications system and to alter the appearance of the display based on the required bandwidth.

According to one embodiment, the controller visually represents available bandwidth on the display via a first icon, and the controller visually represents required bandwidth via a second icon. The first and second icons may be visually represented in comparative size and shape relation to show available bandwidth in relation to required bandwidth on the mobile terminal display. In this embodiment, the controller is capable of controlling the operation of the display in response to the determination of available bandwidth and the determination of required bandwidth so as to visually present this information to the mobile terminal user.

In another embodiment the terminal can also include a display capable of representing both the first and second icons in color. In this embodiment, the controller is configured to present the second icon in a plurality of colors depending on the ratio of the required bandwidth to the available bandwidth. The controller, upon determining this ratio is adapted to display the second icon in a color to indicate to the mobile terminal user whether or not excess bandwidth for additional communication signals is available. In another embodiment, the controller is configured to present the first icon in a plurality of colors corresponding to the type of communications network currently being utilized by the mobile terminal. In yet another embodiment, the controller is configured to change the display color corresponding to the overall level of available bandwidth without the use of a particular icon.

According to various embodiments, the controller is configured to determine various bandwidth variables and to control the operation of the display to visually represent the bandwidth variables to the mobile terminal user. For example, the controller can determine and visually represent: (1) available bandwidth only (using an icon or a color scheme), (2) both available and required bandwidth (using two relatively sized and shaped icons and/or color schemes), (3) available bandwidth and type of communications signal being utilized (using an icon of a size and shape to indicate available bandwidth and a color to indicate the type of communications signal being utilized), and (4) available bandwidth, required bandwidth, and communications signal being utilized (using a combination of the above color and icon size and shape configurations). The controller may also be capable of separately determining the bandwidth available for signal transmission and the bandwidth available for signal reception, and of controlling the display to separately visually represent the signal transmission bandwidth and the signal reception bandwidth.

According to other aspects of the present invention, a method and computer program product are provided for visually representing the available bandwidth and, in some embodiments, the required bandwidth. In addition, a system is provided in which a representation of the bandwidth available to a first terminal, as well as other related information, may be displayed upon the display of another terminal. In this regard, a first terminal may transmit and/or receive signals via a communications system. A controller may determine the available bandwidth, as well as any related information such as the required bandwidth, the type of communications system, etc. A second terminal may include a display that presents a representation of the available bandwidth and any related information, as determined by the controller and provided to the second terminal.

The present invention therefore provides an improved terminal, system, method and computer program product that allows a user of the terminal to easily and conveniently determine the available bandwidth on a given communications network as well as the bandwidth required for transmitting and receiving signals on a given communications network. Thus, the terminal, method and computer program product of the present invention allow the user to easily determine whether or not the required bandwidth is available for the mobile terminal, such as to communicate on several communications networks concurrently without compromising the speed or the quality of the network communications.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of a mobile station that may operate as a terminal, according to embodiments of the present invention;

FIG. 3 is a flowchart illustrating various steps in a method and computer program product of operating a mobile station in the context of determining available bandwidth and controlling the terminal display to visually represent the available bandwidth;

FIG. 4 is a flowchart illustrating various steps in a method and computer program product of operating a mobile station in the context of determining available and required bandwidth and controlling the terminal display to visually represent the available and required bandwidth;

FIG. 5 is a flowchart illustrating various steps in a method and computer program product of operating a mobile station in the context of determining available bandwidth and the type of communications system and controlling the terminal display to visually represent the available bandwidth and the type of communications system;

FIG. 6 is a flowchart illustrating various steps in a method and computer program product of operating a mobile station in the context of determining available bandwidth, required bandwidth, and the type of communications system and controlling the terminal display to visually represent the available bandwidth, required bandwidth, and type of communications system;

FIG. 7 is a flowchart illustrating various steps in a method and computer program product of operating a mobile station in the context of determining available and required bandwidth, controlling the terminal display to visually represent the available and required bandwidth, calculating a ratio of required bandwidth to available bandwidth, and controlling the terminal display to visually represent the ratio of required bandwidth to available bandwidth;

FIG. 8 is a flowchart illustrating various steps in a method and computer program product of operating a mobile station in the context of determining available bandwidth, required bandwidth and type of communications system, controlling the terminal display to visually represent the available bandwidth, required bandwidth and type of communications system, calculating a ratio of required bandwidth to available bandwidth, and controlling the terminal display to visually represent the ratio of required bandwidth to available bandwidth;

FIG. 9 is a depiction of the first and second icons generated according to one embodiment of the invention showing a visual representation of maximum available bandwidth versus minimum required bandwidth;

FIG. 10 is a depiction of the first and second icons generated according to one embodiment of the invention showing a visual representation of maximum available bandwidth with medium required bandwidth;

FIG. 11 is a depiction of the first and second icons generated according to one embodiment of the invention showing a visual representation of maximum available bandwidth with maximum required bandwidth;

FIG. 12 is a depiction of the first and second icons generated according to one embodiment of the invention showing a visual representation of medium available bandwidth with minimum required bandwidth;

FIG. 13 is a depiction of the first and second icons generated according to one embodiment of the invention showing a visual representation of medium available bandwidth with medium required bandwidth;

FIG. 14 is a depiction of the first and second icons generated according to one embodiment of the invention showing a visual representation of medium available bandwidth with maximum required bandwidth;

FIG. 15 is a depiction of the first and second icons generated according to one embodiment of the invention showing a visual representation of minimum available bandwidth with minimum required bandwidth;

FIG. 16 is a depiction of the first and second icons generated according to one embodiment of the invention showing a visual representation of minimum available bandwidth with medium required bandwidth;

FIG. 17 is a depiction of the first and second icons generated according to one embodiment of the invention showing a visual representation of minimum available bandwidth with maximum required bandwidth;

FIG. 18 is a depiction of the first and second icons generated according to one embodiment of the invention showing a visual representation of no available bandwidth with minimum required bandwidth;

FIG. 19 is a depiction of the first and second icons generated according to one embodiment of the invention showing a visual representation of no available bandwidth with medium required bandwidth; and

FIG. 20 is a depiction of the first and second icons generated according to one embodiment of the invention showing a visual representation of no available bandwidth with maximum required bandwidth.

### DETAILED DESCRIPTION OF THE PREFERRED EMBODIMENT(S)

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

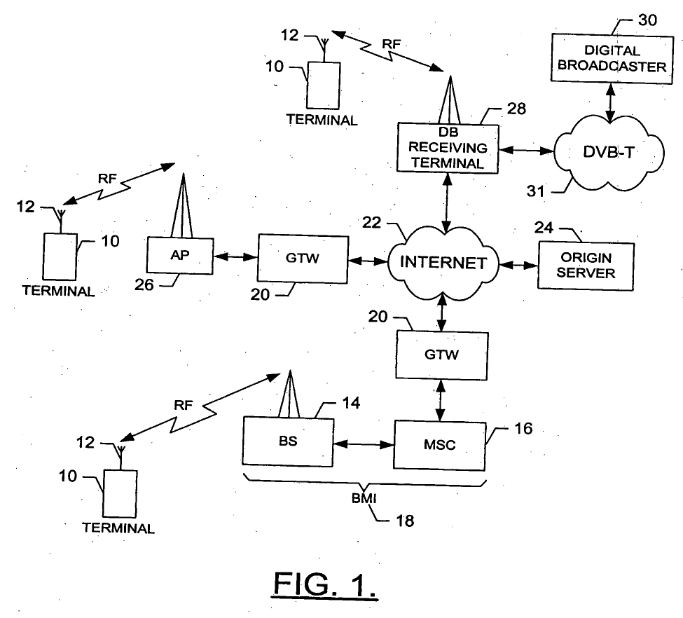

Referring to FIG. 1, an illustration of one type of terminal and system that would benefit from the present invention is provided. The terminal, method and computer program product of embodiments of the present invention will be primarily described in conjunction with mobile communications applications. It should be understood, however, that the terminal, method and computer program product of embodiments of the present invention can be utilized in conjunction with a variety of other applications, both in the mobile communications industries and outside of the mobile communications industries. For example, the terminal, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI) 18. In operation, the MSC is capable of routing calls and messages to and from the terminal when the terminal is making and receiving calls. The MSC also provides a connection to landline trunks when the terminal is involved in a call. Further, the MSC can be coupled to a server gateway (GTW) 20.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with an origin server 24 or the like, as illustrated in FIG. 1.

In addition to, or in lieu of, being coupled to the BS 14, the terminal 10 can be coupled to may be wirelessly coupled to one or more wireless access points (APs) 26. In turn, the APs may be coupled to the Internet 22. Like with the MSC 16, the APs can be directly coupled to the Internet. In one advantageous embodiment, however, the APs are indirectly coupled to the Internet via a GTW 20. As will be appreciated, by directly or indirectly connecting the terminals and the origin server 24, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

The terminal 10 can additionally, or alternatively, be coupled to a digital broadcast (DB) receiving terminal 28. In turn, the digital broadcast receiving terminal can be coupled to a digital broadcaster 30 via a digital broadcast network, such as a terrestrial digital video-broadcasting (DVB-T) network 31. In this regard, the digital broadcaster can comprise a DVB-T transmitter, and the digital broadcast receiving terminal can comprise a DVB-T receiver in the form of a set top box. The terminal can be directly coupled to the digital broadcast receiving terminal, such as via a personal area network (PAN). In one advantageous embodiment, however, the terminal can additionally or alternatively be indirectly coupled to the digital broadcast receiving terminal via the Internet 22. As will be appreciated, by directly or indirectly connecting the terminals and the digital broadcast receiving terminal, the terminals can receive content, such as content for one or more television, radio and/or data channels, from the digital broadcaster.

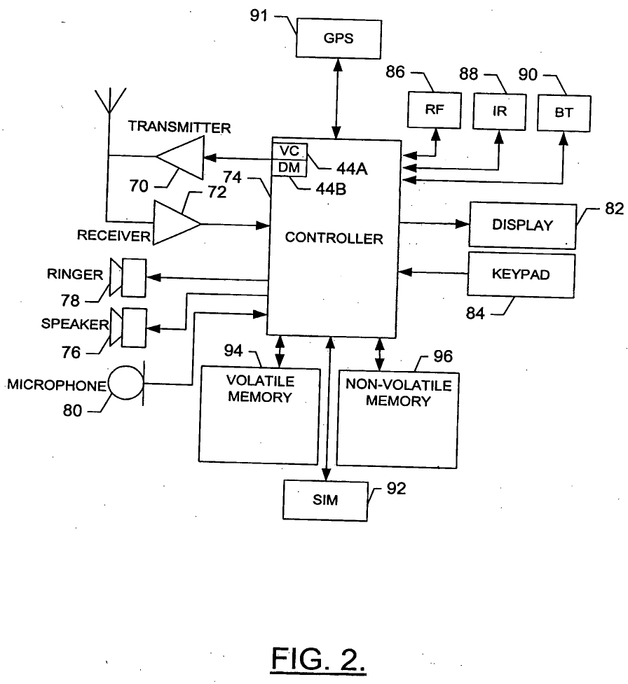

FIG. 2 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). The mobile station can further be capable of operating in accordance with any of a number of different digital broadcasting techniques, such as the DVB technique (e.g., DVB-T, ETSI Standard EN 300 744). Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionally to operate one or more software applications, including the computer program product embodiments of the present invention, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 24, an AP 26, a digital broadcast receiving terminal 28, a digital broadcaster 30 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency (GPRS, for example) and/or infrared (IRDA, for example) techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques.

The mobile station can further include memory, such as a subscriber identity module (SIM) 92, a removable user identity module (R-UIM) or the like, which typically stores information elements related to a mobile subscriber. In addition to the SIM, the mobile station can include other memory. In this regard, like the digital broadcast receiving terminal 28 and the digital broadcaster 30, the mobile station can include volatile memory 94. Also, again like the digital broadcast receiving terminal and the digital broadcaster, the mobile station can include other non-volatile memory 96, which can be embedded and/or may be removable. For example, the other non-volatile memory can comprise embedded or removable multimedia memory cards (MMC's), Memory Sticks manufactured by Sony Corporation, EEPROM, flash memory or the like, such as that available from the SanDisk Corporation of Sunnyvale, Calif., or Lexar Media Inc. of Fremont, Calif.

The memories 92, 94, 96 can store any of a number of pieces of information, and data, used by the mobile station to implement the functions of the mobile station. For example, the memories can store an identifier, such as an international mobile equipment identification (IMEI) code, capable of uniquely identifying the mobile station, such as to the MSC 16. The memories can also store content, such as that received from an origin server 24 and/or a digital broadcast receiving terminal. Also, for example, the memories can also store user or host applications such as a conventional text viewer, audio player, video player, multimedia viewer or the like.

As indicated in the background section, although conventional terminals are capable of determining and controlling the terminal display 82 to visually represent network signal strength, it is desirable to obtain further information regarding the bandwidth currently available for the mobile terminal 10, as well as, in some embodiments, the bandwidth required by the terminal of one of the many means for sharing and/or obtaining data from electronic devices in accordance with any of a number of different wireline and/or wireless techniques. As such, and in accordance with embodiments of the present invention, the controller 74 is capable of determining the available bandwidth of the currently utilized communications system(s) by, for example, monitoring information regarding the available bandwidth provided by the wireless communications system via the receiver 72 and/or by an RF communications system, an IR communications system, a Bluetooth communications system or the like via RF transceiver 86, IR transceiver 88, and Bluetooth transceiver 90, respectively. In addition, the controller 74 is also capable of determining the type of communications system(s) currently in use as well as the bandwidth required by the terminal 10 to effectively utilize the communication system(s) by monitoring the signals transmitted and/or received via the transmitter 70 and the receiver 72, respectively, as well as the signals transmitted and received by transceivers, 86, 88, 90. While several different types of communications systems have been described above, these communications systems have been described by way of example as the mobile terminal 10 may be adapted to communicate via still other types of communications systems and the controller 74 may correspondingly be adapted to monitor the signals transmitted and received via these other communications systems to determine the available bandwidth on each communication system and, in some embodiments, the bandwidth on each communication system required by the terminal.

The controller 74 has the capability to send this information to the display 82 in order to visually inform the user of one or more of the following: available bandwidth, required bandwidth, and the type of communications system currently in use by the terminal 10. Moreover, the controller can separately determine the bandwidth available for signal transmission, i.e., the uplink, and the bandwidth available for signal transmission, i.e., the downlink. The controller 74 can be configured to send this information to the display 82 such that the bandwidth(s) and type of communications system are visually represented as, for example, relatively sized icons of various shapes, colors, and combinations thereof to quickly alert the user of the terminal 10 of their current status. While the display 82 of some embodiments may be monochrome, the display 82 is typically capable of displaying multiple colors. For more details on a color-capable display 82, that could be used in the various embodiments of the present invention, see European Patent Application No. EP 1109147 entitled: System for Color Illumination of a Display, filed Nov. 27, 2000.

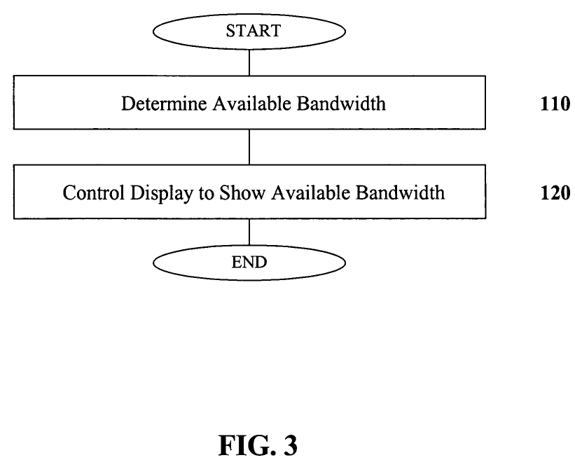

According to one embodiment of the present invention, as illustrated in the block diagram of FIG. 3, the controller, typically operating under the control of a computer program product as described below, implements a method for displaying bandwidth information that consists of a two step process which includes: first, in block 110, the step of determining the available bandwidth, followed by, in block 120, the step of controlling a visual display to show the available bandwidth to a user. As noted above, the controller 74 typically monitors the receiver 72 and/or transceivers 86, 88, 90 to determine the available bandwidth of the currently selected communication system(s) based upon information provided by the communications system(s). The controller 74 then drives or activates the display 82 to visually represent the available bandwidth, using, for instance, a first icon 210, and/or a first color.

For example, the controller 74 may direct the display 82 to depict the first icon 210 as a large icon when there is a generally wide spectrum of available bandwidth. Further, the first icon 210 may be displayed as a medium-sized, or small icon when there is a medium or narrow spectrum of available bandwidth, respectively. Alternatively, the first icon 210 may be depicted in different shapes to indicate that the available bandwidth is wide, medium, narrow, or non-existent. The method of FIG. 3 may further utilize colors to indicate the general level of available bandwidth, such that the controller 74 may direct the display 82 to be wholly or partially backlit in green, yellow, or red, to indicate a generally wide, medium, or narrow spectrum of available bandwidth, respectively. Obviously, this color scheme is chosen only for purposes of example and other color schemes may likewise be utilized. Further, the controller 74 may be configured to direct the display 82 to impart such colors to the differently sized first icons 210 described above to further emphasize to the terminal user the currently available bandwidth.

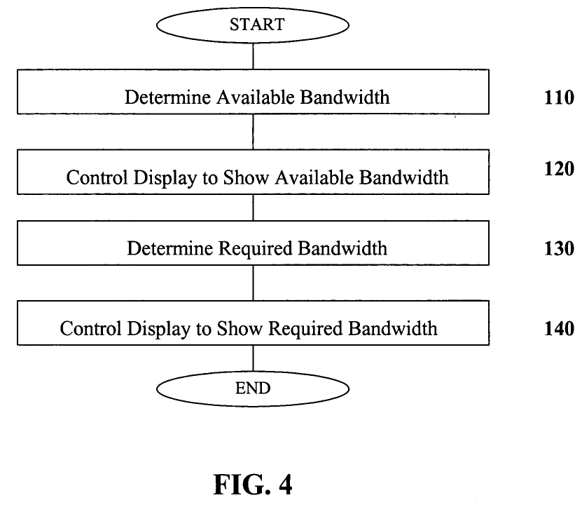

According to a second embodiment of the present invention, FIG. 4 illustrates, in a block diagram, a method, generally implemented by the controller 74 operating under control of a computer program product, for displaying bandwidth information consisting of a four-step process wherein the first two steps are identical to those described in conjunction with FIG. 3 above, see blocks 110 and 120. The embodiment of FIG. 4 includes additional steps shown in blocks 130 and 140 respectively. Block 130 illustrates the additional step of determining the bandwidth required from each of the communications system(s) currently being utilized to support the communications currently being conducted by the mobile terminal 10, and block 140 further illustrates the step of controlling the visual display 82 to also depict the bandwidth required from each of the communications system(s) currently being utilized. The controller 74 typically determines the bandwidth required from each of the communications system(s) that are currently being utilized by monitoring the transmitter 70, the receiver 72, and transceivers 86, 88, 90 of the illustrated embodiment. The controller 74 then directs or activates the display 82 to visually represent the bandwidth required from each of the communications system(s) currently being utilized, using, for instance, a second icon 220, and/or a second color.

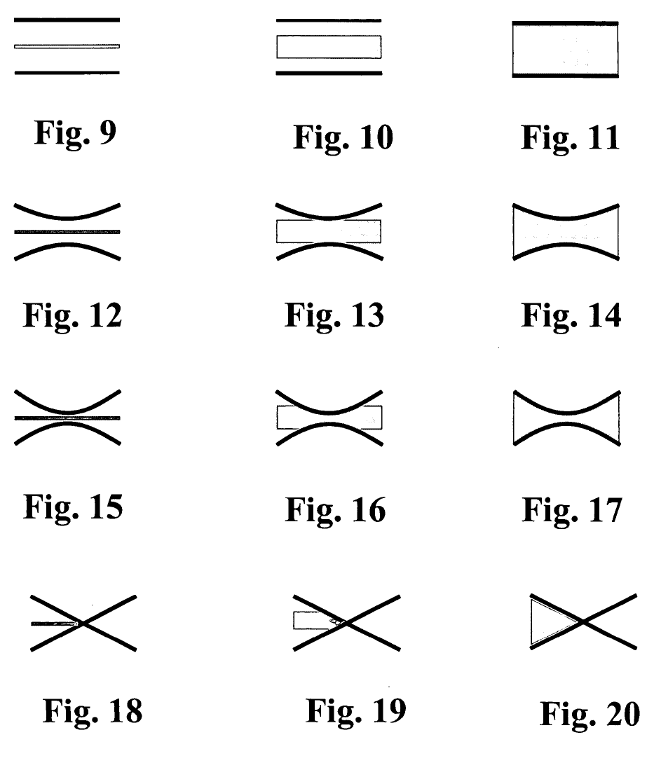

As described above, the controller 74 typically drives the display 82 to depict a first icon 210 representing the available bandwidth. Thus, in the second embodiment of FIG. 4, the controller also drives the display to depict a second icon 220 that may have a relative size or shape in relation to a first icon 210 to visually represent what fraction of the available bandwidth is being currently utilized by the current communication system(s) (as shown, for example in FIGS. 9-20 of this application). For example, if the terminal is currently utilizing 50% of the available bandwidth of a particular communication system, the second icon may be half the size of the first icon. In addition, the second icon 220 representing required bandwidth may be shown in a color to represent what fraction of the currently available bandwidth is being utilized. For instance, the second icon 220 may be depicted in the color green to indicate when the required bandwidth is less than the available bandwidth. The second icon 220 may also be depicted in the color yellow to indicate when the required bandwidth is equal to the available bandwidth. In addition, the second icon 220 may be depicted in the color red to indicate when the required bandwidth is greater than the available bandwidth. The use of color and relatively sized icons in conjunction with the method depicted in FIG. 4 may quickly alert the user of the mobile terminal 10 when the required bandwidth is exceeding the currently available bandwidth, and thus compromising one or more of the modes of communication currently in use by the terminal 10.

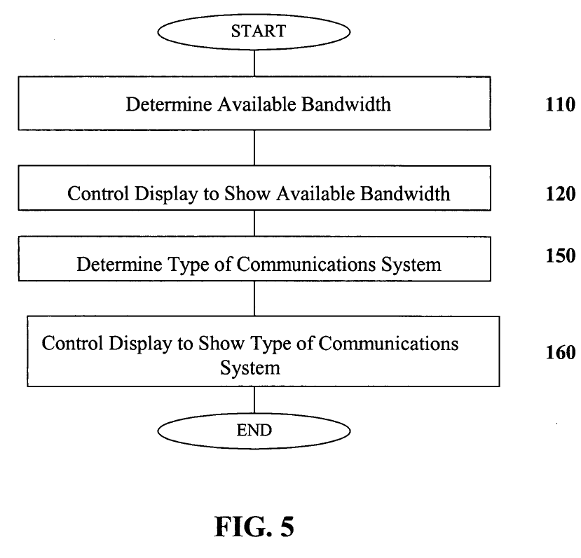

In instances in which the terminal is or may communicate via two or more different communication systems, the controller may separately monitor the available and required bandwidth of each communication system and may generate unique icons representative of each communication system to provide the user with still additional information. According to a third embodiment of the present invention, FIG. 5 illustrates, in a block diagram, a method, typically implemented by the controller 74 operating under control of a computer program product, for displaying bandwidth information consists of a four-step process wherein the first two steps determine the bandwidth available from each of the communications system(s) currently in use as described above in conjunction with FIG. 3, see blocks 110 and 120, and the additional steps shown in blocks 150 and 160 determine the type of communications system(s) currently being utilized and provide a representation thereof for the user. In this regard, block 150 illustrates the additional step of determining the type of communications system(s) currently in use, such as by monitoring the transmitter 70, receiver 72 and/or transceivers 86, 88 and 90 as described above. As shown in block 160, the controller then drives the visual display 82 to show the type of communications system(s) currently in use to a terminal user. For instance, the controller 74 may drive or activate the display 82 to visually represent the current type of communication system(s), using, for instance, a first icon 210 shown in a particular color.

In accordance with the steps illustrated in blocks 110 and 120, a first icon 210 may be displayed to indicate the available bandwidth, and further, accordance with the method depicted in FIG. 5, the first icon 210 may be displayed in a color to indicate the type of communications system being currently utilized by the terminal 10. For instance, the controller 74 may direct the display 82 to depict the first icon 210 in a color to indicate the type of communications system while still controlling the display 82 to depict the size and/or shape of the icon to indicate a spectrum of available bandwidth as described above in the methods of FIG. 3 and FIG. 4. For instance, the controller 74 may direct the display 82 to depict the first icon 210 in the color blue to indicate a Bluetooth connection currently in use, or alternatively, in yellow or purple to indicate a WLAN or GPRS connection, respectively. Alternative color schemes for the first icon 210 could also be utilized to indicate the current use of other communication systems.

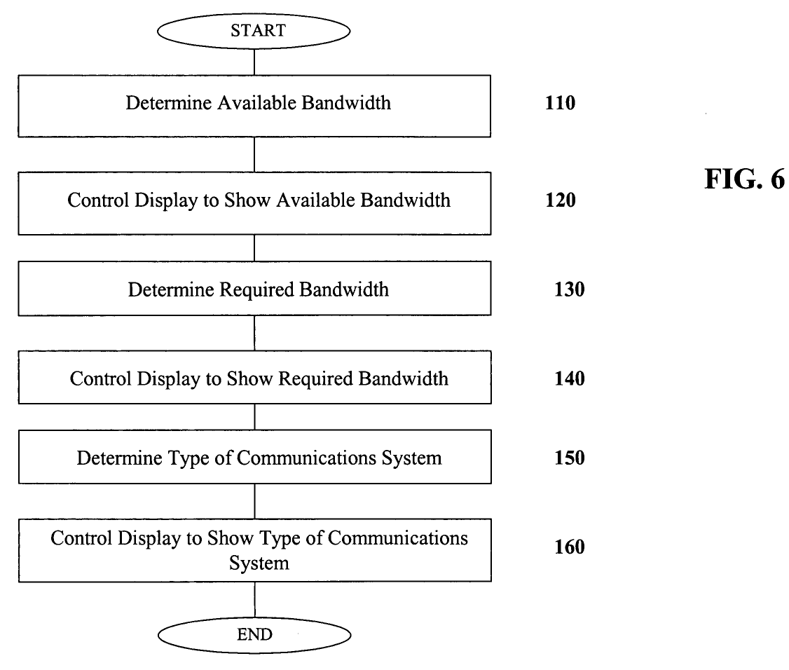

According to a fourth embodiment of the present invention depicted in FIG. 6, the controller 74, typically operating under control of a computer program product, may determine the available bandwidth, the required bandwidth and the type of each communications system(s) currently utilized by the terminal 10, and may then direct the display 82 to provide a representation of the available bandwidth, the required bandwidth and the type of each communications system(s). In this embodiment, the visual representation of available and required bandwidth may be accomplished, for example, via the controller 74 directing the display 82 to depict a first 210 and second icon 220 in a comparative size and/or shape relation as described above. In addition, for example, the controller 74, may direct the display to depict the first icon 210, representing available bandwidth as described above, in a color to further represent the type of communication system currently utilized by the terminal 10. In addition, the alternative color depictions described in accordance with FIGS. 3, 4, and 5 above may also be utilized to more clearly depict a ratio of required bandwidth to available bandwidth.

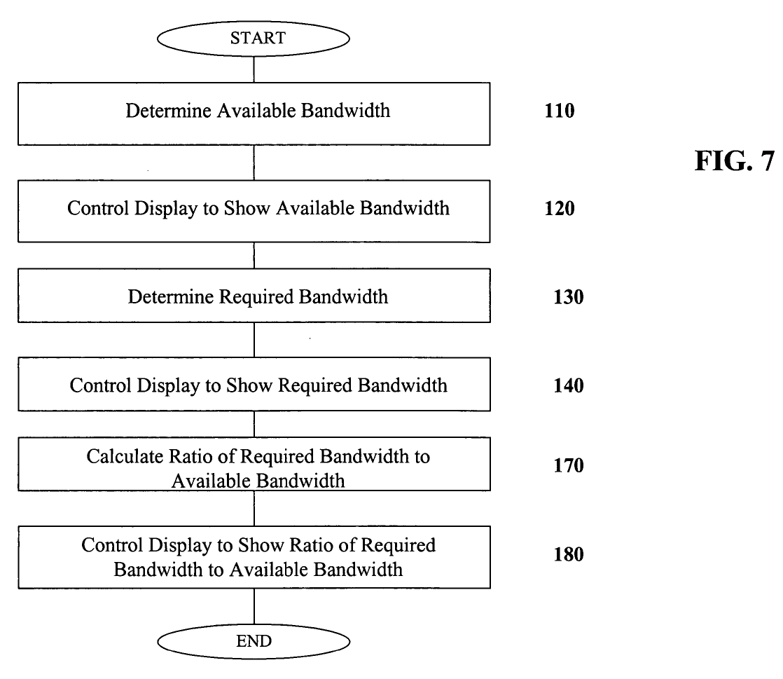

According to a fifth embodiment of the present invention, FIG. 7 illustrates, in a block diagram, a method, typically implemented by the controller 74 operating under control of a computer program product, for determining and displaying the available bandwidth and the required bandwidth for the communications system(s) currently being utilized as described above, such as in conjunction with FIG. 4 above, see blocks 110, 120, 130, and 140, and for also determining and displaying the ratio the required bandwidth to the available bandwidth, as shown in blocks 170 and 180. In this regard, block 170 illustrates the additional step of calculating the ratio of the required bandwidth for communications to the available bandwidth for a respective communications system, and block 180 further illustrates the step of controlling a visual display to show the result of the ratio calculation. For instance, the controller 74 may drive or activate the display 82 to visually represent the ratio by depicting the second icon 220 in a color to represent the varying value of the calculated ratio.

As described generally in conjunction with FIG. 4, the calculated ratio may be visually depicted by presenting the second icon 220 in the color green when the ratio is less than 1 (indicating that required bandwidth is less than available bandwidth). Alternatively, the second icon 220 may be presented in the color yellow when the ratio is equal to 1 (indicating that the required bandwidth is equal to the available bandwidth). Finally, the second icon 220 may be presented in the color red when the ratio is greater than 1 (indicating that there is a shortage of available bandwidth in relation to the bandwidth required by the current attempted signal transfer). Other color schemes as well as other techniques for representing the ratio of required bandwidth to available bandwidth may be utilized without departing from the spirit and scope of the present invention.

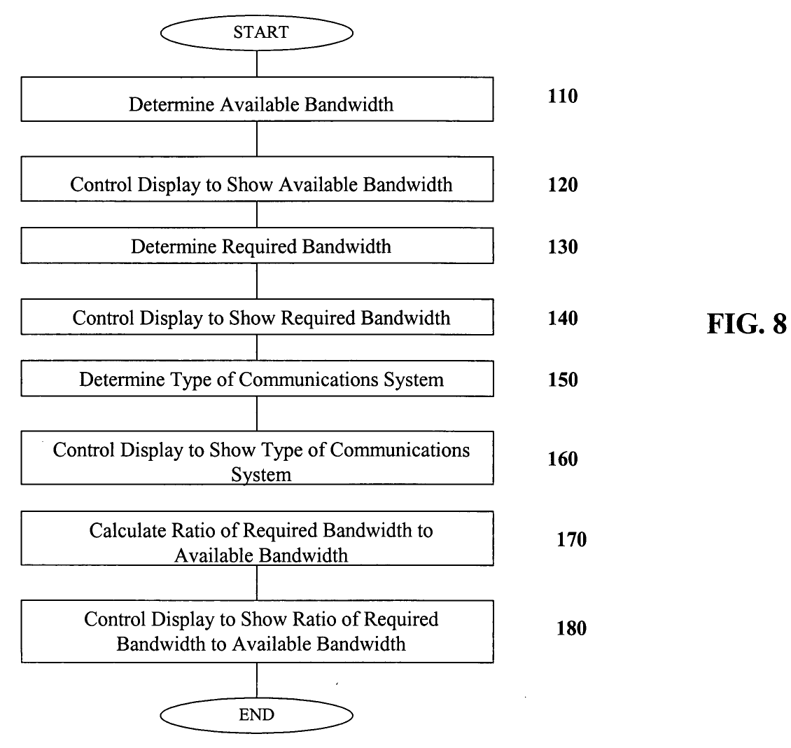

According to a sixth embodiment of the present invention, FIG. 8 illustrates, in a block diagram, a method, typically implemented by the controller 74 operating under control of a computer program product, for displaying the available bandwidth, the required bandwidth, the ratio of the required bandwidth to the available bandwidth and the type of communications system(s) currently being utilized as shown in blocks 110, 120, 130, 140, 150, 160, 170, and 180 which are described above in conjunction with FIGS. 3, 4, 5, 6, and 7. As in the previously described embodiments, the controller 74 may direct the display 82 to depict bandwidth, signal type, and bandwidth ratio information using both icon and color configurations.

The controller 74 may also separately determine the bandwidth available for signal transmission and the bandwidth available for signal reception, especially in instances in which the uplink and downlink may be different. As such, the controller 74 of this embodiment may direct the display to separately depict the signal transmission bandwidth and the signal reception bandwidth, such as by means of separate icons and/or by means of distinct color, shape and/or animation associated with either the uplink or the downlink. In addition, the controller 74 may separately determine the uplink bandwidth that is required and the downlink bandwidth that is required, if so desired.

FIGS. 9-20 depict several views of exemplary first 210 and second icons 220 for depicting both required and available bandwidth simultaneously on a display 82. The examples pictured in FIGS. 9-20 may be analogized to a “stream” or “river” wherein a first icon 210 corresponding to the available bandwidth, is depicted as two parallel horizontal lines representing the “banks” of a “river.” A second icon 220, corresponding to the required bandwidth, is depicted as a band within the parallel “banks” of the first icon 210 to represent a flow of “water” or communications signals, through the “banks” of the available bandwidth.

FIG. 9 depicts the first icon 210 and second icon 220, such as depicted on a display 82 to visually represent maximum available bandwidth and minimum required bandwidth. Maximum available bandwidth is shown by depicting the first icon 210 as a pair of horizontal parallel lines. Minimum required bandwidth is shown by depicting the second icon 220 as a thin horizontal line located within the first icon 210.

FIG. 10 depicts the first icon 210 and second icon 220 configured on a display 82 to visually represent maximum available bandwidth and medium required bandwidth. In this case, medium required bandwidth is shown by depicting the second icon 220 as a thick horizontal band located within the first icon 210.

FIG. 11 depicts the first icon 210 and second icon 220, such as depicted on a display 82 to visually represent maximum available bandwidth and maximum required bandwidth. In this case, maximum required bandwidth is shown by depicting the second icon 220 as a shaded area filling the space within the first icon 210.

FIG. 12 depicts the first icon 210 and second icon 220, such as depicted on a display 82 to visually represent medium available bandwidth and minimum required bandwidth. In this case, medium available bandwidth is shown by depicting the first icon 210 as a pair of horizontally opposed concave lines. In this depiction, the point at which the lines most closely approach one another represents a medium level of the available bandwidth, while the points at which the lines are furthest apart represents the maximum available bandwidth. As shown, the medium available bandwidth is about 50% to 60% of the maximum available bandwidth in this example.

FIG. 13 depicts the first icon 210 and second icon 220, such as depicted by a display 82 to visually represent medium available bandwidth and medium required bandwidth.

FIG. 14 depicts the first icon 210 and second icon 220, such as depicted by a display 82 to visually represent medium available bandwidth and maximum required bandwidth. In this case, the maximum required bandwidth is shown constricted by the outer bounds of the concave lines of the first icon 210 to indicate that the maximum required bandwidth exceeds the available bandwidth and that signal transfer from the terminal 10 may be compromised.

FIG. 15 depicts the first icon 210 and second icon 220, such as depicted by a display 82 to visually represent minimum available bandwidth and minimum required bandwidth. In this case, minimum available bandwidth is shown by depicting the first icon 210 as a pair of closely spaced horizontally opposed concave lines. In this depiction, the point at which the lines most closely approach one another represents the minimum available bandwidth, while the points at which the lines are furthest apart represents the maximum available bandwidth. As shown, the minimum available bandwidth is about 10% of the maximum available bandwidth in this example.

FIG. 16 depicts the first icon 210 and second icon 220, such as depicted by a display 82 to visually represent minimum available bandwidth and medium required bandwidth. In this case, the medium required bandwidth is shown constricted by the outer bounds of the concave lines of the first icon 210 to indicate that the required bandwidth exceeds the available bandwidth and that signal transfer from the terminal 10 may be compromised.

FIG. 17 depicts the first icon 210 and second icon 220, such as depicted by a display 82 to visually represent minimum available bandwidth and medium required bandwidth. In this case, the maximum required bandwidth is shown constricted by the outer bounds of the concave lines of the first icon 210 to indicate that the required bandwidth exceeds the available bandwidth and that signal transfer from the terminal 10 may be compromised.

FIG. 18 depicts the first icon 210 and second icon 220, such as depicted by a display 82 to visually represent that there is no available bandwidth, while also representing the minimum required bandwidth. In this case, no available bandwidth is shown by depicting the first icon 210 as a pair of crossed lines, thereby “blocking” the “stream” of required bandwidth. Thus, the minimum required bandwidth is shown blocked by the crossed lines of the first icon 210 to indicate that no required bandwidth is available and that signal transfer from the terminal 10 is compromised. Likewise, FIGS. 19 and 20 depict the first icon 210 and second icon 220, such as depicted by a display 82 to visually represent that there is no available bandwidth, while also representing the medium required bandwidth and the maximum required bandwidth, respectively.

The icons can be represented in a number of alternative manners with FIGS. 9-20 merely provided examples. By way of further example, the first icon 210 and second icon 220 can be depicted on a terminal display 82 as a pair of rectangular shapes wherein the first icon is represented as an outer rectangle and the second icon is represented as an inner rectangle. The controller 74 could then direct the display 82 to resize the first and second icons to reflect the changing status of the available and required bandwidths. In yet another alternative, the first 210 and second icons 220 can be depicted as a pair of concentric circles configured and displayed in the same manner as the rectangular icons described above to reflect the changing status of the available and required bandwidths.

While the foregoing embodiments of the present invention have displayed a representation of the available bandwidth, as well as other related information, upon the display of the terminal 10 for which the available bandwidth and, in some instances, the required bandwidth is determined, the representation of the available bandwidth and any related information may be displayed upon the display of another terminal in accordance with other embodiments. In this regard, a first terminal may transmit and/or receive signals via a communications system. As described a controller may determine the available bandwidth, as well as any related information such as the required bandwidth, the type of communications system, etc. The controller may also separately determine the uplink bandwidth and the downlink bandwidth, both in terms of the available bandwidth and the required bandwidth if desired. A second terminal, such as either a mobile station or a fixed terminal, may include a display that presents a representation of the available bandwidth and any related information, as determined by the controller and provided to the second terminal. As will be apparent, the controller may be onboard the first terminal, or may be remote from and in communication with the first terminal according to this alternative embodiment.

The user of the second terminal may utilize the information regarding the bandwidth available to the first terminal, as well as any related information, in a variety of manners. For example, upon seeing that the first terminal is currently utilizing all or virtually of the available bandwidth, the user of the second terminal may delay transmitting a file to the first terminal until some subsequent time at which the first terminal is not utilizing as large a percentage of the available bandwidth.

According to one aspect of the present invention, portions of the terminal 10 of the present invention generally operate under control of a computer program product. The computer program product for performing the methods of embodiments of the present invention includes a computer-readable storage medium, such as the non-volatile storage medium 96, and computer-readable program code portions, such as a series of computer instructions, embodied in the computer-readable storage medium.

In this regard, FIGS. 3-8 are functional block diagrams and flowcharts of methods and program products according to the invention. It will be understood that each block or step of the block diagram and flowcharts, and combinations of blocks in the block diagram and flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the block diagram and flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the block diagram and flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the block diagram and flowcharts.

Accordingly, blocks or steps of the block diagram and flowcharts support combinations of means for performing the specified functions, combinations of steps for performing the specified functions and program instruction means for performing the specified functions. It will also be understood that each block or step of the block diagram and flowcharts, and combinations of blocks or steps in the block diagram and flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A terminal adapted to communicate via at least one communications system, wherein the terminal comprises:
a transmitter and a receiver for transmitting and receiving signals, respectively, via the at least one communications system;
a display capable of visually representing an available bandwidth of a current communications system; and
a controller capable of determining the available bandwidth of the current communications system and altering the appearance of the display based on a determination of the available bandwidth.

2. A terminal according to claim 1, wherein the controller is further capable of determining a required bandwidth for transmitting and receiving signals on the current communications system, and wherein the display is further capable of visually representing the required bandwidth for transmitting and receiving signals on the current communications system.

3. A terminal according to claim 1, adapted to communicate via a plurality of different communications systems, wherein the controller is further capable of determining the current communications system on which the terminal is transmitting and receiving signals, and wherein the display is further capable of visually representing the current communications system on which the terminal is transmitting and receiving signals.

4. A terminal according to claim 2, wherein the controller is further capable of determining the current communications system on which the terminal is transmitting and receiving signals, and wherein the display is further capable of visually representing the current communications system on which the terminal is transmitting and receiving signals.

5. A terminal according to claim 1, wherein the controller is capable of separately determining the bandwidth available for signal transmission and the bandwidth available for signal reception, and wherein the controller is further capable of directing the display to separately visually represent the respective bandwidths available for signal transmission and signal reception.

6. A terminal according to claim 1, wherein the controller is further capable of directing the display to visually represent the available bandwidth using a first icon corresponding to the available bandwidth.

7. A terminal according to claim 1, wherein the controller is further capable of directing the display to visually represent the available bandwidth using a first color corresponding to the available bandwidth.

8. A terminal according to claim 2, wherein the controller is further capable of directing the display to visually represent the available bandwidth using a first icon corresponding to the available bandwidth and wherein the controller is further capable of directing the display to visually represent the required bandwidth using a second icon corresponding to the required bandwidth.

9. A terminal according to claim 8, wherein the controller is further capable of directing the display to visually represent the first icon in comparative relation to the second icon such that the controller is further capable of directing the display to visually represent the available bandwidth in relation to the required bandwidth, respectively.

10. A terminal according to claim 9, wherein the controller is further capable of directing the display to visually represent the second icon in a second color used to indicate a value of a ratio of the required bandwidth to the available bandwidth.

11. A terminal according to claim 3, wherein the controller is further capable of directing the display to visually represent the available bandwidth using a first icon corresponding to the available bandwidth.

12. A terminal according to claim 11, wherein the controller is further capable of directing the display to visually represent the first icon in a third color used to indicate the type of the current communications system on which the terminal is transmitting and receiving signals.

13. A terminal according to claim 4, wherein the controller is further capable of directing the display to visually represent the available bandwidth using a first icon corresponding to the available bandwidth and wherein the controller is further capable of directing the display to visually represent the required bandwidth using a second icon corresponding to the required bandwidth.

14. A terminal according to claim 13, wherein the controller is further capable of directing the display to visually represent the first icon in comparative relation to the second icon such that the controller is further capable of directing the display to visually represent the available bandwidth in relation to the required bandwidth, respectively.

15. A terminal according to claim 14, wherein the controller is further capable of directing the display to visually represent the second icon in a second color used to indicate a value of a ratio of the required bandwidth to the available bandwidth.

16. A terminal according to claim 15, wherein the controller is further capable of directing the display to visually represent the first icon in a third color used to indicate the type of communications system on which the terminal is transmitting and receiving signals.

17. A system comprising:
a first terminal comprising a transmitter and a receiver for transmitting and receiving signals, respectively, via the at least one communications system;
a controller capable of determining the available bandwidth of the communications system utilized by said first terminal; and
a second terminal, responsive to said controller, comprising a display capable of visually representing an available bandwidth of the communications system utilized by said first terminal.

18. A system according to claim 17, wherein the controller is further capable of determining a required bandwidth for transmitting and receiving signals on the communications system utilized by said first terminal, and wherein the display of said second terminal is further capable of visually representing the required bandwidth for transmitting and receiving signals on the communications system utilized by said first terminal.

19. A system according to claim 17, wherein said first terminal is adapted to communicate via a plurality of different communications systems, wherein the controller is further capable of determining the current communications system on which said first terminal is transmitting and receiving signals, and wherein the display of said second terminal is further capable of visually representing the current communications system on which said first terminal is transmitting and receiving signals.

20. A system according to claim 17 wherein said controller is capable of separately determining the bandwidth available for signal transmission by said first terminal and the bandwidth available for signal reception by said first terminal, and wherein the display of said second terminal is capable of separately visually representing the respective bandwidths available to said first terminal for signal transmission and signal reception.

21. A method of visually quantifying bandwidth on a terminal adapted to communicate via at least one communications system, said method comprising:
transmitting and receiving signals on at least one communications system;
determining an available bandwidth of a current communications system; and
controlling a display of the terminal to visually represent the available bandwidth of the current communications system.

22. A method according to claim 21, further comprising:
determining a required bandwidth for transmitting and receiving signals on the current communications system; and
controlling the display of the terminal to visually represent the required bandwidth for transmitting and receiving signals on the current communications system.

23. A method according to claim 21, further comprising:
determining a type of the current communications system on which the terminal is transmitting and receiving signals; and
controlling the display of the terminal to visually represent the type of the current communications system on which the terminal is transmitting and receiving signals.

24. A method according to claim 22, further comprising:
determining a type of the current communications system on which the terminal is transmitting and receiving signals; and
controlling the display of the terminal to visually represent the type of the current communications system on which the terminal is transmitting and receiving signals

25. A method according to claim 21 wherein determining the available bandwidth comprises separately determining the bandwidth available for signal transmission and the bandwidth available for signal reception, and wherein controlling the display comprises controlling the display to separately visually represent the respective bandwidths available for signal transmission and signal reception.

26. A method according to claim 21, wherein controlling the display of the terminal further comprises representing visually the available bandwidth using a first icon corresponding to the available bandwidth.

27. A method according to claim 21, wherein controlling the display of the terminal further comprises representing visually the available bandwidth using a first color corresponding to the available bandwidth.

28. A method according to claim 22, wherein controlling the display of the terminal further comprises:
representing visually the available bandwidth using a first icon corresponding to the available bandwidth; and
representing visually the required bandwidth using a second icon corresponding to the required bandwidth.

29. A method according to claim 28, wherein controlling the display of the terminal further comprises representing visually the first icon in comparative relation to the second icon

30. A method according to claim 29, wherein controlling the display of the terminal further comprises:
calculating a ratio of the required bandwidth to the available bandwidth; and
representing visually the second icon in a second color used to indicate a value of a ratio of the required bandwidth to the available bandwidth.

31. A method according to claim 23, wherein controlling the display of the terminal further comprises representing visually the available bandwidth using a first icon corresponding to the available bandwidth.

32. A method according to claim 31, wherein controlling the display of the terminal further comprises representing visually the first icon in a third color used to indicate the type of the current communications system on which the terminal is transmitting and receiving signals.

33. A method according to claim 24, wherein controlling the display of the terminal further comprises:
representing visually the available bandwidth using a first icon corresponding to the available bandwidth; and
representing visually the required bandwidth using a second icon corresponding to the required bandwidth.

34. A method according to claim 33, wherein controlling the display of the terminal further comprises representing visually the first icon in comparative relation to the second icon.

35. A method according to claim 33, wherein controlling the display of the terminal further comprises:
calculating a ratio of the required bandwidth to the available bandwidth; and
representing visually the second icon in a second color used to indicate a value of a ratio of the required bandwidth to the available bandwidth.

36. A method according to claim 35, wherein controlling the display of the terminal further comprises representing visually the first icon in a third color used to indicate the type of the current communications system on which the terminal is transmitting and receiving signals.

37. A method comprising:
transmitting and receiving signals with a first terminal on the at least one communications system;
determining an available bandwidth of the communications system utilized by the first terminal; and
controlling a display of a second terminal to visually represent the available bandwidth of the communications system utilized by the first terminal.

38. A method according to claim 37, further comprising:
determining a required bandwidth for transmitting and receiving signals with the first terminal on the communications system; and
controlling the display of the second terminal to visually represent the required bandwidth for transmitting and receiving signals on the communications system.

39. A method according to claim 37, further comprising:
determining a type of the current communications system on which the first terminal is transmitting and receiving signals; and
controlling the display of the second terminal to visually represent the type of the current communications system on which the first terminal is transmitting and receiving signals.

40. A method according to claim 37 wherein separately determining the available bandwidth comprises separately determining the bandwidth available for signal transmission by the first terminal and the bandwidth available for signal reception by the first terminal, and wherein controlling the display comprises controlling the display of the second terminal to separately visually represent the respective bandwidths available to the first terminal for signal transmission and signal reception.

41. A computer program product for visually quantifying bandwidth on a terminal adapted to transmit and receive signals on at least one communications system, the computer program product comprising a computer-readable storage medium having computer-readable program code portions stored therein, the computer-readable program code portions comprising:
a first executable portion for determining an available bandwidth of a current communications system; and
a second executable portion for controlling a display of the terminal to visually represent the available bandwidth of the current communications system.

42. A computer program product according to claim 41, further comprising:
a third executable portion for determining a required bandwidth for transmitting and receiving signals on the current communications system; and
a fourth executable portion for controlling the display of the terminal to visually represent the required bandwidth for transmitting and receiving signals on the current communications system.

43. A computer program product according to claim 41, further comprising:
a third executable portion for determining a type of the current communications system on which the terminal is transmitting and receiving signals; and
a fourth executable portion for controlling the display to visually represent the type of the current communications system on which the terminal is transmitting and receiving signals.

44. A computer program product according to claim 42, further comprising:
a fifth executable portion for determining a type of the current communications system on which the terminal is transmitting and receiving signals; and
a sixth executable portion for controlling the display to visually represent the type of the current communications system on which the terminal is transmitting and receiving signals.

45. A computer program product according to claim 41 wherein said first executable portion is capable of separately determining the bandwidth available for signal transmission and the bandwidth available for signal reception, and wherein said second executable portion is capable of controlling the display to separately visually represent the respective bandwidths available for signal transmission and signal reception.

46. A computer program product according to claim 41, wherein the second executable portion is adapted to represent visually the available bandwidth using a first icon corresponding to the available bandwidth.

47. A computer program product according to claim 41, wherein the second executable portion is adapted to represent visually the available bandwidth using a first color corresponding to the available bandwidth.

48. A computer program product according to claim 42, wherein the second executable portion is adapted to represent visually the available bandwidth using a first icon corresponding to the available bandwidth and wherein the fourth executable portion is adapted to represent visually the required bandwidth using a second icon corresponding to the required bandwidth.

49. A computer program product according to claim 48, wherein the second and fourth executable portions are adapted to represent visually the first icon in comparative relation to the second icon

50. A computer program product according to claim 49, further comprising a fifth executable portion for calculating a ratio of the required bandwidth to the available bandwidth, and wherein the fourth executable portion is adapted to represent visually the second icon in a second color used to indicate a value of the ratio of the required bandwidth to the available bandwidth calculated by the fifth executable portion.

51. A computer program product according to claim 43, wherein the second executable portion is adapted to represent visually the available bandwidth using a first icon corresponding to the available bandwidth.

52. A computer program product according to claim 51, wherein the fourth executable portion is adapted to represent visually the first icon in a third color used to indicate the type of the current communications system on which the terminal is transmitting and receiving signals.

53. A computer program product according to claim 44, wherein the second executable portion is adapted to represent visually the available bandwidth using a first icon corresponding to the available bandwidth and wherein the fourth executable portion is adapted to represent visually the required bandwidth using a second icon corresponding to the required bandwidth.

54. A computer program product according to claim 53, wherein the second and fourth executable portions are adapted to represent visually the first icon in comparative relation to the second icon

55. A computer program product according to claim 54, further comprising a seventh executable portion for calculating a ratio of the required bandwidth to the available bandwidth, and wherein the fourth executable portion is adapted to represent visually the second icon in a second color used to indicate a value of a ratio of the required bandwidth to the available bandwidth calculated by the seventh executable portion.

56. A computer program product according to claim 55, wherein the sixth executable portion is adapted to represent visually the first icon in a third color used to indicate the type of the current communications system on which the terminal is transmitting and receiving signals.
